(19) United States
(12) Patent Application Publication
(10) Pub. No.: US 2024/0336240 A1
(43) Pub. Date: Oct. 10, 2024

(54) EMERGENCY BRAKING TRIGGERING DEVICE AND METHOD FOR TRIGGERING EMERGENCY BRAKING OF A VEHICLE

(71) Applicant: Robert Bosch GmhH, Stuttgart (DE)

(72) Inventors: Heiko Kirn, Bietigheim-Bissingen (DE); Gyorgy Csaba, Buxapest (HU); Ulrike Rohwer, Ditzingen (DE)

(21) Appl. No.: 18/585,948

(22) Filed: Feb. 23, 2024

(30) Foreign Application Priority Data
Apr. 4, 2023 (DE) 10 2023 203 118.3

(51) Int. Cl. B60T 7/22; B60T 8/171; B60T 8/58; B60W 60/00

(52) U.S. Cl. CPC B60T 7/22; B60T 8/171; B60T 8/58; B60W 60/0015; B60W 60/0027; B60T 2201/022; B60T 2210/32; B60T 2250/04; B60W 2520/00; B60W 2554/4026; B60W 2554/4029; B60W 2555/20

(57) ABSTRACT

An emergency braking triggering device for a vehicle and a method for triggering emergency braking of a vehicle. It is ascertained whether a prerequisite for a probable collision between the vehicle during continued driving thereof during a specified future time interval within a probable driving corridor and a respective foreign object during movement thereof during the future time interval within a probable movement corridor intersecting the driving corridor, is met. Provided that the at least one prerequisite is met, it is ascertained whether a travel path length of a future travel path of the vehicle within the probable driving corridor to the intersecting probable movement corridor is greater than or equal to a threshold value. Provided that the travel path length is greater than or equal to the threshold value, at least one activation signal is output to at least one brake device of the vehicle.

### CROSS REFERENCE

The present application claims the benefit under 35 U.S. C. § 119 of German Patent Application No. DE 10 2023 203 118.3 filed on Apr. 4, 2023, which is expressly incorporated herein by reference in its entirety.

### FIELD

The present invention relates to an emergency braking triggering device for a vehicle. The present invention also relates to a method for triggering emergency braking of a vehicle.

### BACKGROUND INFORMATION

German Patent Application No. DE 10 2021 205 608 A1 describes, automatic emergency brake systems for vehicles by means of which a vehicle equipped with such an automatic emergency brake system can be autonomously/automatically braked when a high risk of a collision of the vehicle with a foreign vehicle is detected, in such a way that a driving speed of the vehicle is reduced, in particular until the vehicle has been brought to a standstill.

### SUMMARY

The present invention provides an emergency braking triggering device for a vehicle and a method for triggering emergency braking of a vehicle.

The present invention provides advantageous possibilities for reducing or mitigating consequences of accidents for vehicle occupants in a collision of a vehicle front of a foreign vehicle with their vehicle. In particular, it is possible by using the present invention to reduce a conventional risk that braking of the vehicle triggered autonomously/automatically before the vehicle front of the foreign vehicle collides with the vehicle worsens the consequences of accidents for the vehicle occupants. The present invention thus helps to avoid or mitigate a significant disadvantage of conventional emergency brake systems. Above all, it may be ensured by means of the present invention that a vehicle using the present invention is (substantially) autonomously braked only if autonomous braking of the vehicle with high probability does not worsen/hardly worsens the consequences of accidents for its vehicle occupants. As becomes clear from the following description, the present invention can be implemented by means of a simple design/programming of an emergency braking triggering device according to the present invention, or corresponding control electronics. A realization of the present invention is therefore inexpensive and not/hardly associated with a loss of installation space on the vehicle using the present invention.

In an advantageous embodiment of the emergency braking triggering device of the present invention, the electronic device is additionally designed and/or programmed in such a way that it is possible by means of the electronic device to ascertain whether the foreign object intersecting during the future time interval and/or its movement meet at least one specified condition, wherein, provided that the at least one prerequisite is met and the intersecting foreign object and/or its movement meet the sole or at least one of the conditions, even if the travel path length is less than the threshold value, the at least one activation signal can be output to the at least one brake device by means of the electronic device, whereas, provided that the at least one prerequisite is met and the travel path length is less than the threshold value, but the at least one condition is unmet, outputting of the at least one activation signal by means of the electronic device to the at least one brake device is prevented. In this way, it can be ensured that the vehicle equipped with the embodiment described here of the emergency braking triggering device is only braked by means of the at least one brake device activated by the emergency braking triggering device, if autonomous/automatic braking of the vehicle does not contribute/hardly contributes to a worsening of the consequences of accidents for its vehicle occupants.

For example, according to an example embodiment of the present invention, the electronic device can additionally be designed and/or programmed in such a way that it is possible by means of the electronic device, taking into account the environmental information, to ascertain whether the foreign object intersecting during the future time interval meets the specified condition that the intersecting foreign object is a pedestrian, an occupied bicycle, an occupied electric bicycle, an occupied wheel chair, an occupied scooter, an occupied electric scooter, an occupied moped, and/or an occupied motorcycle. The vehicle equipped with the embodiment described here of the emergency braking triggering device is thus braked in the case of a travel path length of less than the threshold value by means of the at least one brake device activated by the emergency braking triggering device, if, due to a comparatively low mass of the respective foreign object, a collision of the vehicle with the foreign object does not endanger/hardly endangers the vehicle occupants of the vehicle.

Likewise, according to an example embodiment of the present invention, the electronic device can additionally be designed and/or programmed in such a way that it is possible by means of the electronic device, taking into account the environmental information, to ascertain whether the movement of the foreign object intersecting during the future time interval meets the specified condition that a current movement speed of the intersecting foreign object is less than a specified speed threshold value. Even at a comparatively low movement speed of the intersecting foreign object, such as at a movement speed below 20 kilometers per hour (km/h), it can be assumed with a certain probability that the intersecting foreign object is a pedestrian, an occupied bicycle, an occupied electric bicycle, an occupied wheel chair, an occupied scooter, and/or an occupied electric scooter. Furthermore, when the vehicle collides with a vehicle front of a motor vehicle having a relatively low movement speed as the intersecting foreign object, a risk of injury to vehicle occupants of the vehicle is relatively low.

Alternatively, or additionally, according to an example embodiment of the present invention, the electronic device can also be designed and/or programmed in such a way that it is possible by means of the electronic device, taking into account the environmental information and the ego driving information, to ascertain whether the movement of the foreign object intersecting during the future time interval meets the specified condition that an inclination angle between the probable driving corridor and the intersecting probable movement corridor is outside a specified angular range. For vehicle occupants, a collision of their vehicle with a vehicle front of an intersecting foreign vehicle is primarily associated with a high risk of injury if the foreign vehicle approaches the vehicle from the side. However, by using the embodiment of the present invention described here of the emergency braking triggering device, it can often be ensured that the foreign vehicle driving laterally into the vehicle equipped with the emergency braking triggering device occurs at a distance from the vehicle occupant compartment of the vehicle.

In addition, according to an example embodiment of the present invention, the electronic device can be designed and/or programmed in such a way that it is possible by means of the electronic device, taking into account the environmental information and the ego driving information, to ascertain whether the movement of the foreign object intersecting during the future time interval meets the specified condition that a probable contact surface of the foreign object present as a foreign vehicle with the vehicle is at a distance from the vehicle front of the foreign object in a probable collision during the future time interval. If the probable contact surface of the foreign object present as a foreign vehicle with the vehicle is relatively far away from the vehicle front of the foreign object, such as in particular at the vehicle rear of the foreign object, autonomous braking of the vehicle is generally only advantageous for the vehicle occupants thereof.

In a further advantageous embodiment of the emergency braking triggering device of the present invention, the electronic device is additionally designed and/or programmed in such a way that, provided that the at least one prerequisite is met and the travel path length is less than the threshold value, outputting of the at least one activation signal by means of the electronic device to the at least one brake device is prevented. In this way too, it can be ensured that the vehicle equipped with the embodiment described here of the emergency braking triggering device is only braked by means of the at least one brake device activated by its emergency braking triggering device, if an (additional) endangerment of its vehicle occupants due to the autonomous/automatic braking can be ruled out with high probability.

As an advantageous development of the present invention, the electronic device can additionally be designed and/or programmed in such a way that the threshold value can be defined by means of the electronic device, at least taking into account a current driving speed of the vehicle. As becomes clear from the following description, by means of this design/programming, the electronic device can take into account that a possible risk of accidents of the vehicle due to autonomous braking of the vehicle is primarily dependent on a current driving speed of the vehicle.

Preferably, according to an example embodiment of the present invention, the electronic device is additionally designed and/or programmed in such a way that it is possible by means of the electronic device to determine a future braking distance of the vehicle that can be brought about by means of the at least one brake device, and it is possible by means of the electronic device to define the threshold value to be equal to the determined braking distance or equal to a sum of the determined braking distance and a specified safety distance or a safety distance defined by the electronic device. By means of the embodiment described here of the emergency braking triggering device, it can thus be reliably predicted whether autonomous braking of the vehicle that can be brought about by means of the at least one brake device activated by the emergency braking triggering device can still prevent a collision thereof with the foreign object.

As a further advantageous development of the present invention, the electronic device can additionally be designed and/or programmed in such a way that the safety distance can be defined by means of the electronic device, at least taking into account the current driving speed of the vehicle, the current movement speed of the foreign object intersecting during the future time interval, and/or at least one provided or requested current ambient and/or weather condition. By means of the embodiment described here of the emergency braking triggering device, it can therefore, for example, also be taken into account that the vehicle formed therewith has a longer-than-average braking distance in the case of rain, black ice, and/or on a falling roadway with a significant slope.

According to an example embodiment of the present invention, performing a corresponding method for triggering emergency braking of a vehicle also creates the advantages described above. It is expressly pointed out that the method for triggering emergency braking can be developed according to the embodiments described above of the emergency braking triggering device.

### BRIEF DESCRIPTION OF THE DRAWINGS

Further features and advantages of the present invention are explained below with reference to the figures.

FIGS. 1A-1D show a flow chart and schematic representations of traffic situations for explaining an example embodiment of the method for triggering emergency braking of a vehicle according to the present invention.

FIG. 2 shows a schematic representation of an example embodiment of the emergency braking triggering device according to the present invention.

### DETAILED DESCRIPTION OF EXAMPLE EMBODIMENTS

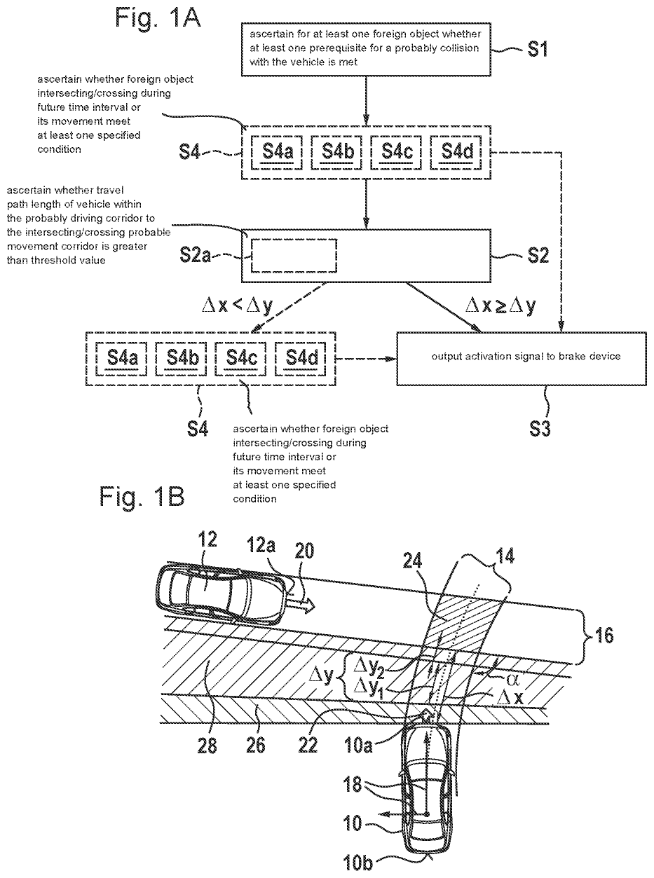

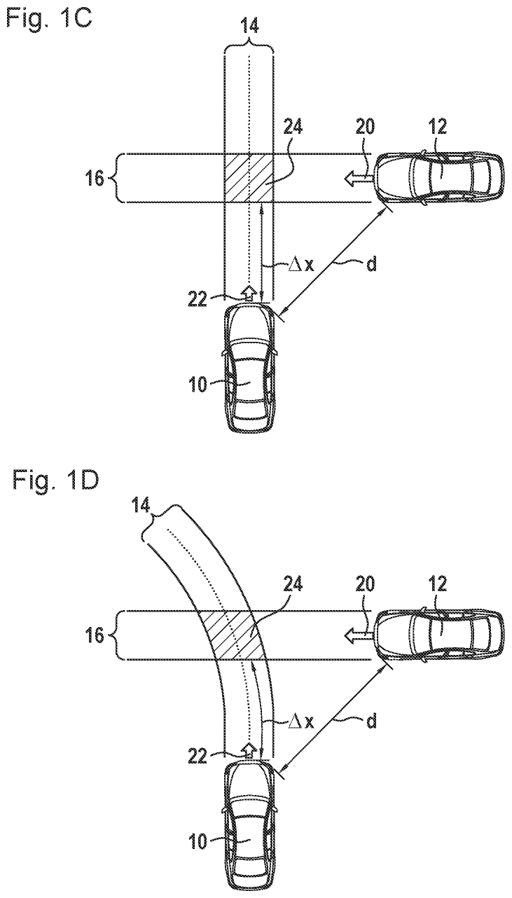

FIGS. 1A to 1D show a flow chart and schematic representations of traffic situations for explaining an embodiment of the method for triggering emergency braking of a vehicle.

It is expressly pointed out that feasibility of the method described below is not limited to a specific vehicle type/motor vehicle type of the vehicle/motor vehicle 10. The vehicle 10 for which the method described below is performed may, for example, be understood as an electric bicycle, an electric scooter, a moped, a motor vehicle, a passenger car, a truck, or an agricultural commercial vehicle. If the term “vehicle” is used below, it is to be understood to mean a so-called ego vehicle.

If desired, the method described below may be performed during every trip of the vehicle 10 at a respective driving speed within a forward-driving speed range specified for forward driving of the vehicle 10 (e.g., from 1 kilometer per hour (km/h) to 90 kilometers per hour (km/h)) and/or within a backward-driving speed range specified for backward driving of the vehicle 10 (e.g., from 1 kilometer per hour (km/h) to 45 kilometers per hour (km/h)). Likewise, the method may also be performed during every forward driving of the vehicle 10 and/or during every backward driving of the vehicle 10.

The method described below comprises a method step S1, which is performed at least once during a trip of the vehicle 10 intended for performing the method. Preferably, method step S1 is repeated at a specified repetition frequency during the trip of the vehicle 10 intended for performing the method.

When performing method step S1, it is in each case ascertained for at least one foreign object 12 moving in at least one subenvironment of the vehicle 10, whether at least one specified prerequisite for a probable collision between the vehicle 10 and the respective foreign object 12 is met/present during a specified future time interval. In this case, it is taken into account that the probability of a collision between the vehicle 10 and the respective foreign object 12 depends both on continued driving of the vehicle 10 during the future time interval and on a movement of the respective foreign object 12 during the future time interval. The continued driving of the vehicle 10 during the future time interval is to be understood to mean driving within a probable driving corridor 14 of the vehicle 10. Accordingly, the movement of the respective foreign object 12 during the future time interval is to be understood to mean a movement within a probable movement corridor 16 intersecting the driving corridor 14. In particular, during the future time interval, the probable driving corridor 14 of the vehicle 10 and the probable movement corridor 16 of the respective foreign object 12 may also cross.

Method step S1 is performed taking into account (at least) one piece of environmental information provided by at least one environmental sensing device (not shown) of the vehicle 10. For example, the environmental information may include a current position of the respective foreign object 12 (specifically within a coordinate system 18 fixed to the vehicle 10), a current movement speed of the respective foreign object 12, a current movement acceleration of the respective foreign object 12, a current movement direction 20 of the respective foreign object 12, and/or an object type of the respective foreign object 12. The object type of the respective foreign object 12 can, for example, be understood to mean whether the respective foreign object 12 is a pedestrian, an occupied bicycle, an occupied electric bicycle, an occupied wheel chair, an occupied scooter, an occupied electric scooter, an occupied moped, an occupied motorcycle, a passenger car, a truck, or an agricultural commercial vehicle. The environmental information may also reflect a course of a roadway on which the vehicle 10 currently drives, in particular a course of a lane on which the vehicle 10 currently drives, and/or a course of a roadway on which the respective foreign object 12 currently drives, in particular a course of a lane on which the respective foreign object 12 currently drives.

Additionally, ego driving information provided by at least one sensor, control, and/or information output device (not shown) of the vehicle 10 is also taken into account when performing method step S1. In particular, the ego driving information may reflect at least a current driving speed of the vehicle 10, a current driving acceleration of the vehicle 10, and/or a current driving direction 22 of the vehicle 10. (The position of the vehicle 10 within the fixed coordinate system 18 is always constant.) Alternatively, or additionally, the ego driving information may also include information regarding a previous travel route of the vehicle 10, a previous driving mode of the vehicle 10, a current driving mode of the vehicle 10, and/or a probable future travel route of the vehicle 10. As the at least one sensor, control, and/or information output device, at least one sensor of the vehicle 10, an automatic driving system of the vehicle 10, and/or a navigation system of the vehicle 10 can be used, for example.

On the basis of the data/information listed herein, it can be ascertained relatively reliably whether the at least one specified prerequisite for a probable collision between the vehicle 10 and the respective foreign object 12 during the future time interval is met/present. In particular, the probable driving corridor 14 of the vehicle 10 and the probable movement corridor 16 of the foreign object 12 can be predicted by means of an electronic device (not shown) of the vehicle 10 designed and/or programmed for this purpose. The data/information listed above generally allow for a comparatively accurate prediction of the probable driving corridor 14 of the vehicle 10 within the future time interval and of the probable movement corridor 16 of the respective foreign object 12 within the future time interval.

The at least one specified prerequisite to be met for a collision that is probable between the vehicle 10 and the respective foreign object 12 during the future time interval may, for example, be that the probable driving corridor 14 of the vehicle 10 within the future time interval and the probable movement corridor 16 of the respective foreign object 12 within the future time interval intersect or cross, and that, at least one time within the future time interval, both the vehicle 10 and the respective foreign object 12 are present in and/or directly at an intersection area 24 of the probable driving corridor 14 with the probable movement corridor 16. Since calculation options for performing such predictions are convention in the related art, they are not discussed in more detail here.

If, when performing method step S1, it is ascertained that the at least one specified prerequisite for a collision that is probable between the vehicle 10 and the respective foreign object 12 during the future time interval is met/present, a method step S2 is performed. In method step S2, it is ascertained whether a travel path length Δx of the vehicle 10 within the probable driving corridor 14 to the intersecting/crossing probable movement corridor 16 is greater than or equal to a specified or determined threshold value Δy. As illustrated in FIG. 1B, the travel path length Δx is to be understood to mean a distance that extends from a reference point on the vehicle 10 to the intersection area 24 of the probable driving corridor 14 with the probable movement corridor 16. The travel path length Δx may in particular extend between a vehicle front 10a of the vehicle 10 and the intersection area 24. The travel path length Δx preferably runs centrally through the probable driving corridor 14 of the vehicle 10.

As illustrated by FIGS. 1C and 1D, the travel path length Δx may vary depending on the course of the probable driving corridor 14 of the vehicle 10, in particular depending on a possible curvature of the probable driving corridor 14 of the vehicle 10. Although the foreign object 12 in the traffic situations illustrated by FIGS. 1C and 1D is at the same distance d from the vehicle 10, the travel path length Δx for the probable driving corridor 14 when the vehicle 10 drives straight ahead (in FIG. 1C) deviates significantly from the travel path length Δx for the probable driving corridor 14 when the vehicle 10 drives through curves (in FIG. 1D). The illustration of the probable movement corridor 16 of the respective foreign object 12 as a “straight line” in FIGS. 1B to 1D is also to be interpreted only as an example. For example, the probable movement corridor 16 of the respective foreign object 12 can also be curved, in particular while or before the respective foreign object 12 drives through curves.

If, when performing method step S2, it is determined that the travel path length Δx is greater than or equal to the threshold value Δy, then, as method step S3, at least one activation signal is output to at least one brake device (not shown) of the vehicle 10 such that the vehicle 10 is braked by means of the at least one brake device activated by the at least one activation signal. This can also be described in that emergency braking of the vehicle 10 is autonomously/automatically triggered as method step S3. Preferably, after an autonomous/automatic triggering of the emergency braking (by means of method step S3), the started emergency braking is continued even if the decreasing travel path length Δx becomes less than the threshold value Δy. The emergency braking started autonomously/automatically by means of method step S3 can in particular also be continued after the vehicle 10 has reached the intersection area 24. However, autonomously triggering the emergency braking of the vehicle 10 by means of method step S3 occurs only sometimes, provided that the at least one specified prerequisite for a collision that is probable between the vehicle 10 and the respective foreign object 12 during the future time interval is met.

The method described herein thus eliminates the conventional disadvantage of automatic emergency brake systems of the prior art, which automatically trigger emergency braking of the ego vehicle every time it is detected that there is an acute risk of a collision between an ego vehicle and a further road user. The automatic emergency brake systems of the prior art do not take into account that automatically triggered emergency braking can contribute to the additional endangerment of vehicle occupants of the ego vehicle in the event of a nevertheless occurring collision of the ego vehicle with the further road user. In particular, the automatic braking of the ego vehicle can have the result that a contact surface of a vehicle front of the further road user in the event of the collision thereof with the ego vehicle is closer to the vehicle occupants, whereas only a vehicle rear of the ego vehicle would be “impacted” by the further road user in the case of a non-braked trip of the ego vehicle. This can also be described in such a way that automatic emergency brake systems of the prior art often only help to displace the contact surface of the vehicle front of the further road user colliding with the ego vehicle closer to the vehicle occupants thereof due to the automatic braking of the ego vehicle, whereby the vehicle occupants of the ego vehicle are additionally endangered. Conventional automatic emergency brake systems can thus additionally increase a risk of injury to vehicle occupants of the ego vehicle when the ego vehicle collides with a further road user.

In contrast to the prior art, in the method described herein, prior to autonomously triggering emergency braking of the vehicle 10, it is first at least examined whether the travel path length Δx is greater than or equal to the threshold value Δy. As becomes clear from the description below, the threshold value Δy can be specified or determined in such a way that it is ensured that, with high probability, autonomous triggering of the emergency braking of the vehicle 10 does not additionally endanger the vehicle occupants thereof. The threshold value Δy can in particular be specified or determined in this way that, in the case of a travel path length Δx of less than the threshold value Δy, the vehicle 10 reaching the intersection area 24 between the probable driving corridor 14 and the probable movement corridor 16 faster is advantageous in order, in this way, to displace a contact surface of a vehicle front 12a of the foreign object 12 with the vehicle 10 in the probable collision closer to a vehicle rear 10b of the vehicle 10, and thus further away from the vehicle occupants thereof. In this way, consequences of accidents for the vehicle occupants of the vehicle 10 in the collision that, with high probability, is no longer avoidable between the vehicle 10 and the foreign object 12 can be reduced or mitigated. The method described herein thus helps to increase a safety standard of the vehicle 10 and to improve the protection of the vehicle occupants thereof.

Method step S2 may comprise a substep S2a in which the threshold value Δy is determined. For example, the threshold value may be defined taking into account the current driving speed of the vehicle 10. In this way, it can be taken into account that the current driving speed of the vehicle 10 has a substantial influence on whether autonomously triggering emergency braking of the vehicle 10 by performing method step S3 is advantageous for the vehicle occupants thereof.

The threshold value Δy may in particular be defined such that, in the case of a travel path length Δx of less than the defined threshold value Δy, a collision of the vehicle 10 with the foreign object 12 is not/hardly avoidable even by means of autonomous braking of the vehicle 10, whereas, in the case of a travel path length Δx greater than or equal to the defined threshold value Δy, the collision can still be prevented by means of the autonomous braking of the vehicle 10. To this end, a future braking distance Δ y₁ of the vehicle 10 that can be brought about (at the present time) by means of the at least one brake device can, for example, be determined in substep S2a. The future braking distance Δ y₁ is to be understood to mean the distance needed to bring the vehicle 10 to a standstill when potentially performing method step S3. The future braking distance Δ y₁ is preferably adapted to the probable driving corridor 14 of the vehicle 10. At least one provided or requested current ambient and/or weather condition may also be taken into account in determining the future braking distance Δ y₁. The at least one current ambient and/or weather condition taken into account in determining the future braking distance Δ y₁ may, for example, be that the vehicle 10 would have to be braked in the case rain, black ice, and/or on a falling roadway with a significant slope when potentially performing method step S3. The threshold value Δy can then be defined to be equal to the determined future braking distance Δ y₁.

As illustrated in FIG. 1B, the threshold value Δy can also be defined to be equal to a sum of the determined future braking distance Δ y₁ and a specified or defined safety distance Δ y₂. As can also be seen in FIG. 1B, the safety distance Δ y₂ may also be adapted to the probable driving corridor 14 of the vehicle 10. Optionally, the safety distance Δ y₂ may also be defined taking into account the current driving speed of the vehicle 10, the current movement speed of the foreign object 12, and/or the at least one provided or requested current ambient and/or weather condition, such as in particular any braking of the vehicle 10 in the case of rain, black ice, and/or on a falling roadway with a significant slope.

If desired, when performing the method illustrated by means of FIGS. 1A to 1D, it is possible, even though the at least one prerequisite is met, to always prevent execution of method step S3 if the travel path length Δx is less than the threshold value Δy. In FIG. 1B, an area 26 indicates at what travel path length Δx the emergency braking of the vehicle 10 is possibly autonomously triggered. In contrast, an area 28 indicates at what travel path lengths Δx starting of the emergency braking of the vehicle 10 is possibly prevented.

Preferably, the method also comprises an (optional) method step S4. In method step S4, it can be ascertained whether the foreign object 12 intersecting/crossing during the future time interval and/or its movement meet at least one specified condition.

For example, in a substep S4a of method step S4, it can be ascertained whether the foreign object 12 intersecting/crossing during the future time interval meets the specified condition that the intersecting/crossing foreign object 12 is a pedestrian, an occupied bicycle, an occupied electric bicycle, an occupied wheel chair, an occupied scooter, an occupied electric scooter, an occupied moped, and/or an occupied motorcycle. Alternatively, or additionally, in a substep S4b of method step S4, it can be examined whether the movement of the foreign object 12 intersecting/crossing during the future time interval meets the specified condition that a current movement speed of the intersecting/crossing foreign object 12 is less than a specified speed threshold value. For example, the speed threshold value may be within a speed range of between 10 kilometers per hour (km/h) and 60 kilometers per hour (km/h). All conditions listed herein indicate that a possible collision of the intersecting/crossing foreign object 12 with the vehicle 10 is not/hardly critical for the vehicle occupants thereof, even if emergency braking of the vehicle 10 is previously autonomously triggered. It is therefore sensible to autonomously trigger the emergency braking of the vehicle 10 by means of method step S3, possibly even if the travel path length Δx is less than the threshold value Δy.

Likewise, in a substep S4c of method step S4, it can be checked whether the movement of the foreign object 12 intersecting/crossing during the future time interval meets the specified condition that an inclination angle α between the probable driving corridor 14 and the intersecting/crossing probable movement corridor 16 is outside a specified angular range. The angular range of 30° to 150° may, for example, be specified. Furthermore, in a substep S4d of method step S4, it can be examined whether the movement of the foreign object 12 intersecting/crossing during the future time interval meets the specified condition that a probable contact surface of the foreign object 12 present as a foreign vehicle with the vehicle 10 is at a distance from the vehicle front 12a of the foreign object 12 in a probable collision during the future time interval. Provided that at least one of the conditions examined by means of substeps S4c and S4d is met, it can be assumed with high probability that, in the event of a possible collision of the intersecting/crossing foreign object 12 with the vehicle 10, the vehicle occupants thereof are hardly additionally endangered due to emergency braking of the vehicle 10 that was previously started autonomously. It is thus advantageous to autonomously trigger emergency braking of the vehicle 10 by means of method step S3 when at least one of the conditions examined by means of substeps S4c and S4d is met, even if the travel path length Δx is less than the threshold value Δy.

Method step S4 can, for example, also be performed before method step S2. In particular, method step S4 can also be a substep of method step S1. If, when performing method step S4 prior to method step S2, it is determined that the intersecting/crossing foreign object 12 and/or its movement meet the sole or at least one of the conditions, method step S3 is performed (regardless of whether the travel path length Δx is less than the threshold value Δy). Performing method step S2 may be dispensed with, where appropriate. If, on the other hand, it is detected when performing method step S4 prior to method step S2 that the at least one condition is unmet, the method is continued with method step S2. If, when performing method step S2 after method step S4, it is determined that the travel path length Δx is less than the threshold value Δy, execution of method step S3 is prevented even though the at least one prerequisite is met (and due to the at least one unmet condition).

Alternatively, method step S4 can always be performed after method step S2 if the travel path length Δx is less than the threshold value Δy. If, when performing method step S4 after method step S2, it is determined that the at least one condition is unmet, execution of method step S3 is prevented. If, however, when performing method step S4 after method step S2, it is detected that the intersecting/crossing foreign object 12 and/or its movement meet the sole or at least one of the conditions, method step S3 is performed.

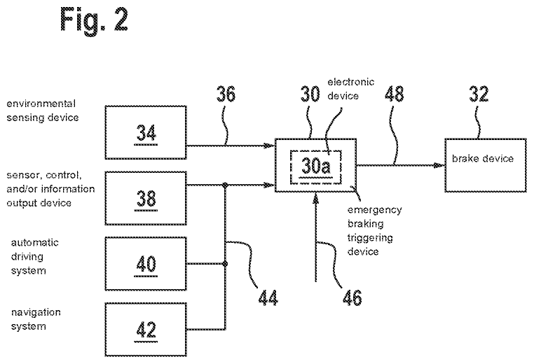

FIG. 2 show a schematic representation of an embodiment of the emergency braking triggering device.

The emergency braking triggering device 30 shown schematically in FIG. 2 can be used/is used in a vehicle/motor vehicle (not shown). It is pointed out that usability of the emergency braking triggering device 30 is not limited to a specific vehicle type/motor vehicle type of the vehicle/motor vehicle. Likewise, designability/programmability of the emergency braking triggering device 30, or its electronic device 30a, is not limited to the functions described below. Instead, the emergency braking triggering device 30/its electronic device 30a may also be designed and/or programmed to perform other functions, which are however not discussed below. The functions of the emergency braking triggering device 30 described below may therefore also be integrated into more versatile control electronics of the vehicle. Corresponding control electronics of the vehicle may, for example, be a control device for at least one brake device 32 of the vehicle and/or a central control unit of the vehicle.

The emergency braking triggering device 30 has its electronic device 30a, which is designed and/or programmed in such a way that, by means of the electronic device 30a, it can be ascertained/is ascertained in each case, for at least one foreign object moving in at least one subenvironment of the vehicle, whether at least one specified prerequisite for a probable collision between the vehicle and the respective foreign object 12 during a specified future time interval due to continued driving of the vehicle during the future time interval and movement of the respective foreign object during the future time interval is met/present. As explained above, the continued driving of the vehicle is to be understood to mean driving the vehicle during the future time interval within a probable driving corridor, and the movement of the foreign object is to be understood to mean a movement of the foreign object within a probable movement corridor intersecting/crossing the driving corridor. Examples of the at least one prerequisite and possibilities for ascertaining whether the at least one prerequisite is met/present are already discussed above.

Ascertaining whether the at least one specified prerequisite is met/present takes place by means of the electronic device 30a, taking into account environmental information 36 provided by at least one environmental sensing device 34, which is comprised by the device or external to the device, and ego driving information 44 provided by at least one sensor, control, and/or information output device 38 to 42. The at least one sensor, control, and/or information output device 38 to 42 may, for example, be at least one sensor 38 of the vehicle, an automatic driving system 40 of the vehicle, and/or a navigation system 42 of the vehicle. The environmental sensing device 34 may, for example, comprise at least one radar sensor, at least one lidar sensor, and/or at least one camera system. Since suitable devices for monitoring at least the subenvironment of the vehicle are conventional in the related art, this is not discussed further here. Additionally, examples of environmental information 36 and ego driving information 44 are already listed above.

Provided that the at least one prerequisite is met, the electronic device 30a is additionally designed and/or programmed in such a way that it can be ascertained/is ascertained by means of the electronic device 30a whether a travel path length of a future travel path of the vehicle within the probable driving corridor to the intersecting probable movement corridor is greater than or equal to a specified are self-defined threshold value. Advantageous possibilities for defining the threshold value by means of the electronic device 30a are already described above. If desired, at least one current ambient and/or weather condition provided by the environmental sensing device 34 and/or requested from an off-board information output device (not shown) may also be taken into account in defining the threshold value.

Provided that the at least one prerequisite is met and the travel path length is greater than or equal to the threshold value, at least one activation signal 48 can be output/is output to the at least one brake device 32 so that the vehicle can be braked/is braked by means of the at least one brake device 32 activated by the at least one activation signal 48. Thus, even by means of the emergency braking triggering device 30/its electronic device 30 described herein, the at least one activation signal can be output/is output to the at least one brake device 32 only if it is ensured that, with high probability, autonomous braking of the vehicle triggered in this manner does not worsen/hardly worsens possible consequences of accidents for the vehicle occupants thereof.

The emergency braking triggering device 30/its electronic device 30 may also be designed/programmed to perform further method steps of the method explained above.

What is claimed is:

1. An emergency braking triggering device for a vehicle, comprising:
an electronic device configured in such a way that, using the electronic device, taking into account environmental information provided by at least one environmental sensing device of the vehicle and ego driving information provided by at least one sensor and/or control and/or information output device of the vehicle, it is ascertained in each case, for at least one respective foreign object moving in at least one subenvironment of the vehicle, whether at least one specified prerequisite for a probable collision between the vehicle during continued driving of the vehicle during a specified future time interval within a probable driving corridor and the respective foreign object during movement of the respective foreign object during the future time interval within a probable movement corridor intersecting the driving corridor is met and, the electronic device is used to output at least sometimes at least one activation signal to at least one brake device of the vehicle so that the vehicle can be braked by the at least one brake device activated by the at least one activation signal;
wherein the electronic device is additionally configured in such a way that the electronic device ascertains whether a travel path length of a future travel path of the vehicle within the probable driving corridor to the intersecting probable movement corridor is greater than or equal to a specified or self-defined threshold value, wherein, provided that the at least one prerequisite is met and the travel path length is greater than or equal to the threshold value, the at least one activation signal can be output to the at least one brake device.

2. The emergency braking triggering device according to claim 1, wherein the electronic device is additionally configured in such a way that, using the electronic device, it is ascertained whether the foreign object intersecting during the future time interval and/or its movement meet at least one specified condition, wherein, provided that the at least one prerequisite is met and the intersecting foreign object and/or its movement meet at least one of the at least one condition, even if the travel path length is less than the threshold value, the at least one activation signal is output to the at least one brake device using the electronic device, whereas, provided that the at least one prerequisite is met and the travel path length is less than the threshold value, but the at least one condition is unmet, outputting of the at least one activation signal using the electronic device to the at least one brake device is prevented.

3. The emergency braking triggering device according to claim 2, wherein the electronic device is additionally configured in such a way that, using the electronic device, taking into account the environmental information, it is ascertained whether the foreign object intersecting during the future time interval meets the specified condition that the intersecting foreign object is a pedestrian and/or an occupied bicycle and/or an occupied electric bicycle and/or an occupied wheel chair and/or an occupied scooter and/or an occupied electric scooter and/or an occupied moped and/or an occupied motorcycle.

4. The emergency braking triggering device according to claim 2, wherein the electronic device is additionally configured in such a way that using the electronic device, taking into account the environmental information, it is ascertained whether the movement of the foreign object intersecting during the future time interval meets the specified condition that a current movement speed of the intersecting foreign object is less than a specified speed threshold value.

5. The emergency braking triggering device according to claim 2, wherein the electronic device is additionally configured in such a way that the electronic device, taking into account the environmental information and the ego driving information, ascertains whether the movement of the foreign object intersecting during the future time interval meets the specified condition that an inclination angle between the probable driving corridor and the intersecting probable movement corridor is outside a specified angular range.

6. The emergency braking triggering device according to claim 2, wherein the electronic device is additionally configured in such a way that the electronic device, taking into account the environmental information and the ego driving information, ascertains whether the movement of the foreign object intersecting during the future time interval meets the specified condition that a probable contact surface of the foreign object present as a foreign vehicle with the vehicle is at a distance from a vehicle front of the foreign object in a probable collision during the future time interval.

7. The emergency braking triggering device according to claim 1, wherein the electronic device is additionally configured in such a way that, provided that the at least one prerequisite is met and the travel path length is less than the threshold value, output of the at least one activation signal using the electronic device to the at least one brake device is prevented.

8. The emergency braking triggering device according to claim 1, wherein the electronic device is configured in such a way that the threshold value can be defined using the electronic device, at least taking into account a current driving speed of the vehicle.

9. The emergency braking triggering device according to claim 1, wherein the electronic device is configured in such a way that the electronic device determines a future braking distance of the vehicle that can be brought about using the at least one brake device, and defines the threshold value to be: (i) equal to the determined braking distance, or (ii) equal to a sum of the determined braking distance and a specified safety distance or one a distance defined by the electronic device.

10. The emergency braking triggering device according to claim 9, wherein the electronic device is additionally configured in such a way that the safety distance is defined using the electronic device, at least taking into account: (i) a current driving speed of the vehicle, and/or (ii) a current movement speed of the foreign object intersecting during the future time interval, and/or (iii) at least one provided or requested current ambient condition and/or (iv) at least one provided or requested current weather condition.

11. A method for triggering emergency braking of a vehicle, comprising the following steps:
ascertaining, taking into account environmental information provided by at least one environmental sensing device of the vehicle and ego driving information provided by at least one sensor and/or control, and/or information output device of the vehicle, in each case for at least one respective foreign object moving in at least one subenvironment of the vehicle, whether at least one specified prerequisite for a probable collision between the vehicle during continued driving of the vehicle during a specified future time interval within a probable driving corridor and the respective foreign object during movement of the respective foreign object during the future time interval within a probable movement corridor intersecting the driving corridor is met;
wherein, at least one activation signal is output at least sometimes to at least one brake device of the vehicle such that the vehicle is braked using the at least one brake device activated by the at least one activation signal;
provided that the at least one prerequisite is met, ascertaining whether a travel path length of a future travel path of the vehicle within the probable driving corridor to the intersecting probable movement corridor is greater than or equal to a specified or determined threshold value;
provided that the travel path length is greater than or equal to the threshold value, outputting the at least one activation signal to the at least one brake device.
